(19) United States
(12) Patent Application Publication
(10) Pub. No.: US 2017/0183781 A1
(43) Pub. Date: Jun. 29, 2017

(54) ELASTOMERIC COATING ON A SURFACE

(71) Applicant: HEWLETT-PACKARD DEVELOPMENT COMPANY, L.P, HOUSTON, TX (US)

(72) Inventors: KUAN-TING WU, TAIPEI CITY (TW); JAMES CHANG, TAIPEI CITY (TW); YU-CHUAN KANG, TAIPEI CITY (TW)

(21) Appl. No.: 15/309,535

(22) PCT Filed: Jul. 29, 2014
(86) PCT No.: PCT/US2014/048675

§ 371 Date: Nov. 8, 2016

(51) Int. Cl. C23C 28/00; B32B 15/08

(52) U.S. Cl. CPC C23C 28/00; B32B 15/08

(57) ABSTRACT

An example composite material composed of a metal or multilayered metal substrate onto which an elastomer or elastomeric mixture is positioned by electrophoretic disposition. The elastomer or elastomeric mixture forms a flexible non-rigid elastomeric coating, which imparts a soft touch tactile feeling to the metal base substrate.

### BACKGROUND

A metal object may be coated with various polymers. Such polymers may be used as protective layers on, for example, seals, surfaces of electronic devices, etc. Such polymeric surfaces, however, are often rigid, difficult to re-work, and use environmentally harmful chemicals in their production.

### BRIEF DESCRIPTION OF THE DRAWINGS

For a detailed description of various examples, reference will now be made to the accompanying drawings in which:

FIG. 1 shows an illustration of a composite material, which comprises a metal member and a non-rigid elastomeric coating, in accordance with various examples;

FIG. 2 shows an illustration of a composite material which comprises a metal member coated with an anodized coating, and a non-rigid elastomeric coating formed on the anodized coating, in accordance with various examples;

FIG. 3 shows an illustration of a composite material which comprises a metal member coated with a physical vapor deposition (PVD) coating onto which a non-rigid elastomeric coating is formed on the PVD coating, in accordance with various examples;

FIG. 4 shows an illustration of a composite material which comprises a metal member coated with an electroplated coating, and a non-rigid elastomeric coating formed on the electroplated coating, in accordance with various examples;

FIG. 5 shows an illustration of a composite material which comprises a metal member coated with an electroless coating, and a non-rigid elastomeric coating formed on the electroless coating, in accordance with various examples;

FIG. 6 shows an illustration of a composite material which comprises a non-metal core, onto which a metal member is coated, and a non-rigid elastomeric coating is formed on the metal member in accordance with various examples; and

FIGS. 7, 8 and 9 show flow charts that illustrate methods of forming a composite material in accordance with various examples.

### DETAILED DESCRIPTION

In the following description, reference is made to the accompanying drawings, which form a part hereof, and in which is shown by way of illustration an example of the disclosed implementations. It is to be understood that other implementations may be utilized and structural changes may be made without departing from the scope of the disclosure.

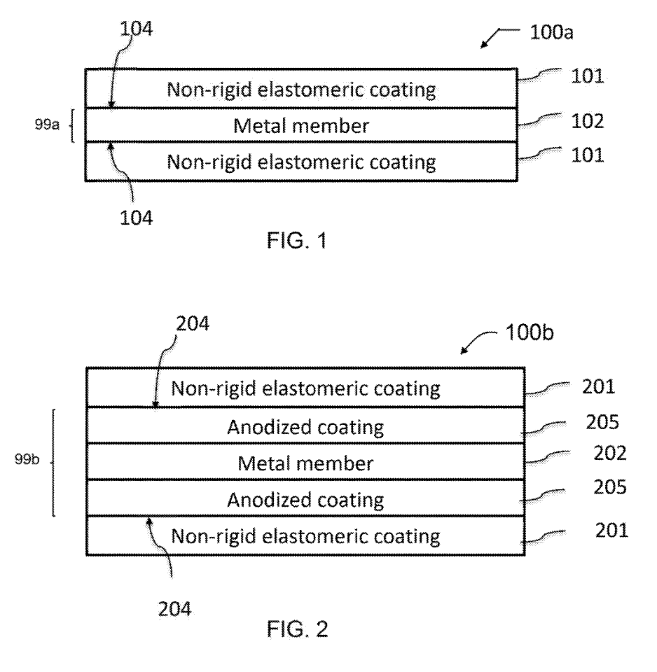

Various examples are shown and described herein of a composite structure. The various composite structures include an object coated with a non-rigid elastomeric coating. The non-rigid elastomeric coating provides the object with a “soft touch” feel. Such “soft touch” coatings provide tactile, softness and aesthetic qualities to a surface, while providing ease of processing and flexibility, and in some examples provides low hardness, low stiffness and high impact resistance. A composite structure that comprises such a soft touch or non-rigid elastomeric surface may comprise electronic goods such as laptops, tablets, and other handheld electronic devices. FIGS. 1-6 provide six examples of cross sections of composite structures. A difference between the various examples is the nature of the substrate being coated with the non-rigid elastomeric coating. The substrates so coated in FIGS. 1-6 are designed as 99a-99f.

An example of a composite structure is described herein and illustrated in FIG. 1 as composite structure 100a. The composite structure 100a of the example of FIG. 1 comprises a substrate 99a that includes a metal member 102 partially or fully coated on one or more of its surfaces with a non-rigid or soft touch elastomeric coating 101. The metal member 102 may be selected from one or more of: aluminum, magnesium, lithium, zinc, titanium, niobium, stainless, copper, or a metal alloy thereof.

In one example, the metal member 102 may be a single metal layer, whereas in other examples the metal member 102 may comprise multiple metal layers that form a multi-layer metal member.

In general, the metal member 102 may have any size or shape. In the example of FIG. 1, the metal member 102 may comprise two opposing surfaces including a first surface 104 and a second surface 104′ onto which the non-rigid elastomeric coating 101 may be deposited by, for example, electrophoretic deposition. The surfaces 104 and 104′ of the metal member 102 may be of equal size and shape (or different sizes and shapes), and may be coated simultaneously in one coating processing operation. The metal member 102 may have any number of surfaces and any or all of such surfaces may be coated with the non-rigid elastomeric coating 101.

FIG. 2 illustrates another composite structure 100b comprising an anodized coating 205 formed on one or more surfaces of a metal member 202. The combination of the metal member 202 and anodized coating 205 represents the substrate 99b onto which a non-rigid elastomeric coating 201 is deposited. The anodized coating 205 may comprise multiple surfaces due to the geometry of the underlying metal member 202. For example, the anodized coating 105 may include a first surface 204 and a second surface 204′ as shown onto which a non-rigid elastomeric coating 201 may be deposited by, for example, electrophoretic deposition. Anodized coatings may be formed at 25° C. to 100° C. and may be 5-150 μm thick.

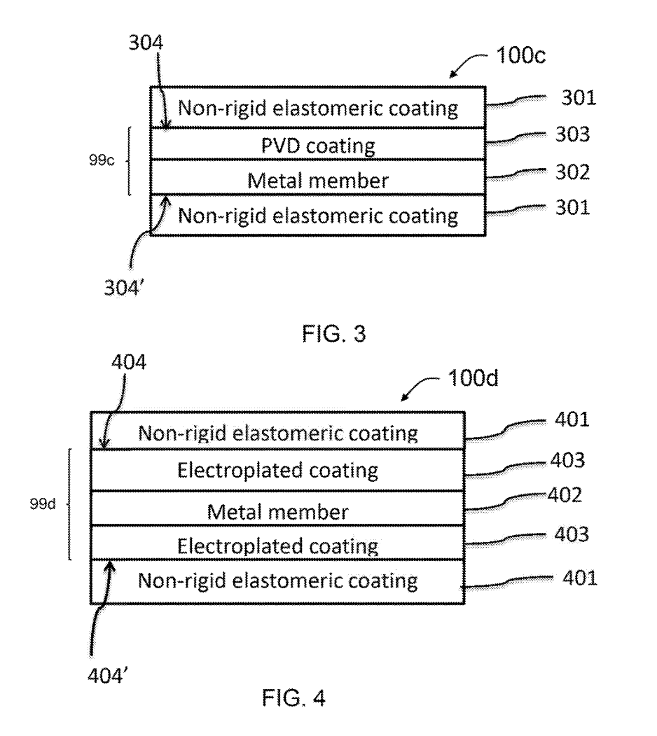

FIG. 3 illustrates yet another example of a composite structure 100c including a substrate 99c. The substrate 99c comprises a metal member 302 and a Physical Vapor Deposition (PVD) coating 303. The PVD coating 303 is coated onto one or more or all surfaces of the metal member 302. As shown in the example of FIG. 3, the PVD coating 303 forms a first surface 304 onto which a non-rigid elastomeric coating 301 may be deposited by, for example, electrophoretic deposition. The metal member 302 comprises a second surface 304′ onto which a non-rigid elastomers coating also is deposited by, for example, electrophoretic deposition.

PVD coatings may include thinly deposited films such as: titanium nitride, zirconium nitride, chromium nitride, titanium aluminum nitride, titanium alloy, aluminum, chromium, nickel, stainless, and diamond like carbon. Such films may have one or all of the following characteristics: hard and corrosion resistant, stable at high temperatures, high impact strength, excellent abrasion resistance, and sufficiently durable and protective. Any or all of these qualities also may be imparted to the composite material described herein. The PVD coating 303 may be formed at 130° C. to 300° C. and may be less than 300 μm thick.

FIG. 4 illustrates a further example of a composite structure 100d which includes a substrate 99d. Substrate 99d comprises a metal member 402 and an electroplated coating 403, which is formed by electroplating one or more or all surfaces of the metal member 402. The electroplated coating 403 has its own surfaces whose size and shape are generally defined by the size and shape of the underlying metal member 402. Suitable electroplated coatings may include copper (Cu), nickel (Ni), and chromium (Cr), may be formed at 25° C. to 80° C. and may be 5-150 μm thick, In one example, the electroplated coating 403 comprises a first surface 404 and a generally opposing second surface 404′ onto which a non-rigid elastomeric coating 401 may be deposited by, for example, electrophoretic deposition.

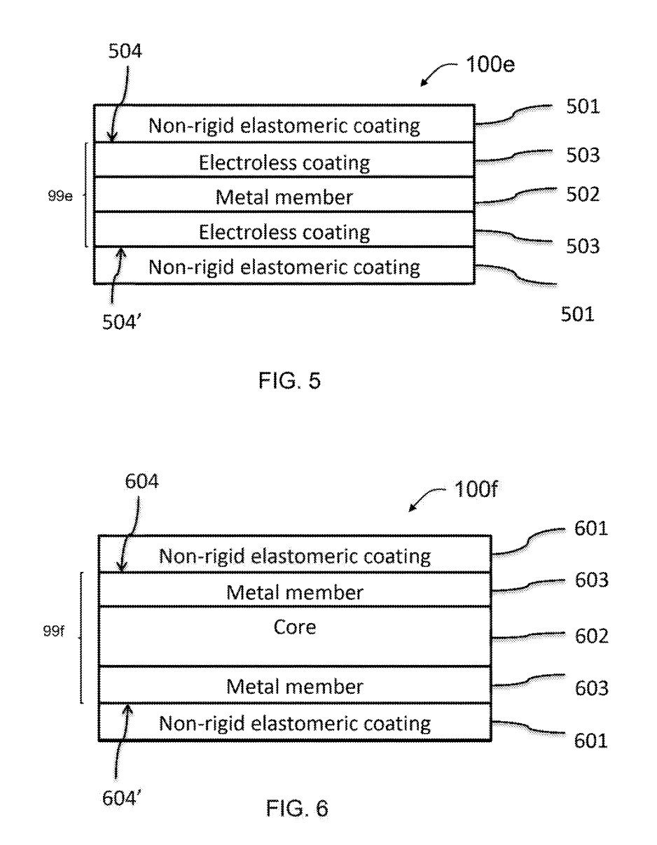

Another example of a composite structure 100e is illustrated in FIG. 5. In this example, the substrate 99e includes a metal member 502 partially or fully coated with an electroless coating 503. The electroless coating 503 is formed on the surface of the metal member 502, and forms in some examples a first surface 504 and a second surface 504′ onto which a non-rigid elastomeric coating 501 may be deposited by, for example, electrophoretic deposition. In some examples, the electroless coating 503 may comprise a chemical including nickel and zinc coatings. The electroless coating 503 may be formed at 25° C. to 75° C. and may be less than 30 μm thick.

In a further example of a composite structure 100f as illustrated in FIG. 6, a substrate 99f may include a core 602 contained within a metal member 603. The core 602 may be formed from a fiber, plastic, multilayer-fiber, hybrid composite, or other type of non-metal material. The metal member 603 may comprise a first surface 604 and an opposing second surface 604′. A non-rigid elastomeric coating 601 may be deposited (e.g., by electrophoretic deposition) on the surfaces 604 and 604′ of the metal member 603 of the substrate 99f.

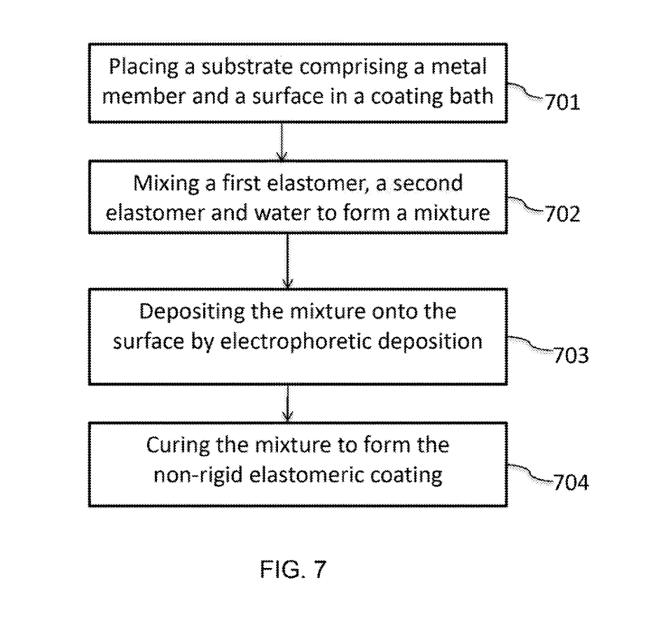

Any or all of the above examples of composite structures may be formed by the method illustrated in FIG. 7. In operation 701 a substrate comprising a metal member and a surface is placed in in a coating bath comprising an electrolytic solution of polymers as explained below. At 702, a first elastomer, a second elastomer and water are mixed to form a mixture, wherein the mixture of polymers comprise thermosetting polymers and thermoplastic polymers as described below. At 703 the mixture is deposited on the surface by electrophoretic deposition. At 704, the mixture is cured to form a non-rigid elastomeric coating.

Any or all of the above examples of composite structures also may be formed by the method illustrated in FIG. 7. In operation 801, a metal member, such as those described above, may be pretreated. Pretreating the metal member may include such operations as: degreasing, chemically polishing, ultrasonically cleaning or a combination of such processes.

At 802, the pretreated metal member may be coated with an anodized coating (as in FIG. 2), a PVD coating (as in FIG. 3)., an electroplated coating (as in FIG. 4), an electroless coating (as in FIG. 5), or other suitable coating.

At 803, an elastomeric mixture may be electrophoretically deposited onto a surface of the metal member or a surface of the coating provided by operation 802. Electrophoretic deposition (EPD) may include submerging the substrate (metal member into a coating bath containing a coating solution (electrolytic), and applying direct current electricity through the bath using electrodes. Suitable voltages for this purpose may be about 30 to about 300 volts DC, and the temperature of the coating bath may be maintained in the range of about 20° C. to about 30° C. In one example, the metal member to be coated is the anode, and a set of “counter-electrodes” or a cathode is used to complete the circuit to cause the EPD to occur.

During the EPD process direct current may be applied to the coating solution, which in some examples is an aqueous solution or dispersion of polymers, elastomers, or elastomeric mixtures, each of which may comprise ionizable groups or groups that generate positively or negatively charged free radicals. The coating solution may also comprise materials such as pigments and fillers, such as carbon black, titanium dioxide, clay, mica, talc, barium sulfate, calcium carbonate, synthetic pigment, metallic powder, aluminum oxide, graphene, graphite, organic powder, inorganic powder or combinations thereof.

When the current is applied, the charged species migrate to the respective electrode with the opposite charge. For example in anodic deposition, the material being deposited will have salts of an acid as the charge-bearing group. These negatively charged anions react with the positively charged hydrogen ions (protons), which are produced at the anode by the electrolysis of water to reform the original acid. The fully protonated acid carries no charge, is less soluble in water, and precipitates out of the aqueous solution to coat the anode. Similarly negatively charged free radicals react with hydrogen ions at the anode and are subsequently deposited at the anode, i.e., electrophoretically depositing the mixture of elastomers on the first surface of the substrate (803).

The thickness of the elastomeric coating deposited on the first surface may be controlled by the rate of deposition (μm of elastomer per second)), or the number of times the metal layer is coated. For example, a thin coating may be applied in a first EPD coating cycle. The EPD coating may be cured and then a second EPD coating may be applied by the same process. Typical non-rigid elastomeric coating thicknesses achieved in the examples illustrated in FIGS. 1-6 are between about 1 μm to about 1000 μm thick in some implementations, about 100 μm to about 600 μm thick in yet other implementations; and about 10 μm to about 60 μm thick in other implementations still. A coating cycle disclosed herein are from 1 to 1000 seconds, 10 to 500 seconds, and 20 to 120 seconds. The rate of deposition is about 0.01 μm to 10 μm per second, 0.1 to 5 μm per second and 0.1 μm to 2 μm per second. The concentration of the charged species in the electrolytic solution is between 5 wt % and 50 wt %; 5 wt % to 25 wt %; and 8 wt % and 20 wt %. Further the thickness of the non-rigid elastomeric layer can be increased by increasing any of the cycle time, concentration of electrolytic species or voltage.

Conversely, in some examples the metal member may be the cathode (if the first surface of the substrate comprises negatively charged species). In this example cathodic deposition may be used, wherein the polymer/elastomer being deposited may have salts of a base as the charge-bearing group. The protonated base will react with the hydroxyl ions being formed by electrolysis of water to yield the neutral base and water. The uncharged polymer is less soluble in water than it was when it was charged, and precipitation onto the cathode may then occur. Similarly, in some examples positively charged free radicals react with hydroxyl ions at the cathode and are subsequently deposited at the cathode.

Examples of electrophoretic coating solutions described herein may include aqueous dispersions of thermoset and thermoplastic elastomers, such as polyurethane elastomers and polyacrylic elastomers, which are examples of free radical initiated elastomers containing monomers based on acrylic acid and methacrylic acid.

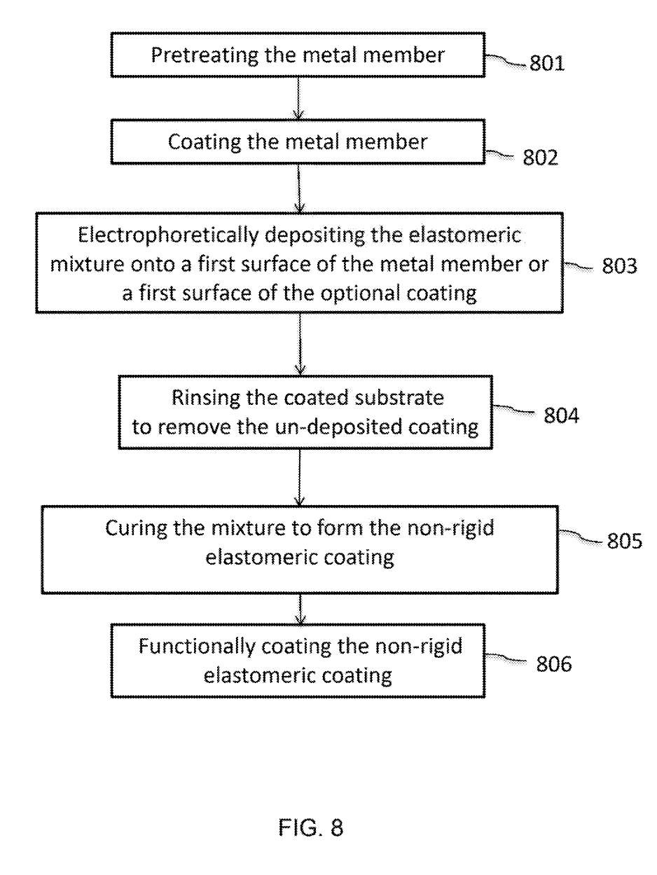

Referring still to FIG. 8, after the deposition operation 803, the coated substrate may be rinsed at 804 to remove the un-deposited coating solution prior to curing.

A curing process 805 then may be performed which crosslinks the polymeric subunits of the elastomers or elastomeric mixture to form the non-rigid elastomeric surface. In examples herein described the deposited elastomers which are coated onto the substrate are heated at a curing temperature of about 120 degree ° C. to about 180 degree ° C. for about 30 minutes to about 60 minutes.

As described above, the elastomers used herein are thermoset or thermoplastic elastomers. Examples of thermoset (or thermosetting) elastomers include, but are not limited to: alkyl acrylate copolymer, butadiene, chlorinated polyethylene (CPE), isobutylene-isoprene copolymer, ethylene propylene (EPM/EPDM), epichlorhydrin (CO/ECO), fluoropolymer, hydrogenated nitrile, isoprene, chloroprene, polysulphide, nitrile, polyurethane (HNBR), silicone, styrene butadiene, tetrafluoroethylene propylene, polyacrylate elastomers or combinations thereof.

Examples of thermoplastic elastomers used herein may include polyurethane elastomers, styrenic block copolymers, copolyether ester elastomers, polyester amide elastomers, or combinations thereof.

Thermoplastic elastomers are materials that repeatedly soften/melt when heated and harden when cooled. Softening/melt temperatures vary with polymer type and grade. When thermoplastic molecular chains are heated the individual polymer chains slip, causing plastic flow. When cooled, the chains of atoms and molecules are held firmly and the elastomer can be molded, but when subsequently heated, the chains will slip again. Thermoset elastomers, on the other hand, undergo a chemical change during heating processing to become permanently insoluble and infusible. It is this chemical cross-linking that is the principal difference between thermoset and thermoplastic systems. As such, the ratio of thermoset to thermoplastic elastomers is selected in the examples described herein so as to impart such properties to the non-rigid elastomeric coating, and thereby controlling the degree of softness or non-rigidity of the surface.

The greater the amount of thermoplastic elastomer in the elastomeric mixture, the greater the amount of thermoplastic elastomer in the non-rigid elastomeric coat and the softer the coating. The softness, soft touch or non-rigidity of the coating can be quantified by the coefficient of static friction of the elastomeric coating. The coefficient of friction (COF) μ describes the ratio of the force of friction between two bodies and the force pressing them together. The coefficient of friction depends on the materials used; for surfaces at rest relative to each other μ=μₛ where μₛ is the coefficient of static friction. The greater the amount of thermoplastic elastomer in the coating the softer or less rigid (non-rigid) the coating. The amount of thermoplastic elastomer in the elastomeric coating is therefore adjusted to produce a non-rigid coating wherein the coefficient of static friction is between 3 and 5 in some implementations, between 2 and 3 in other implementations, between 1 and 2 in yet other implementations, and less than 1 in other implementations. In some examples the coefficient of static friction is 1.6, while in other examples the coefficient of static friction is between 0.01 and 1.6.

Examples of the mixture of elastomers used herein to achieve such non-rigid elastomeric coatings with such coefficients of static friction include ratios of thermoset elastomer to thermoplastic elastomers of 99.9:0.01 to 0.01:99.1. In some examples thermoset to thermoplastic elastomeric ratios may be any of 50:50; 45:55; 40:60; 35:65: 30:70 25:75: 20:80; 15:85; 10:90; 5:95; 2.5:97.5; 1:99; and 0.1:99.9.

In one example less that 30% polyurethane is mixed with a counterbalance of polyacrylamide to produce a mixture of elastomers that is deposited by EPD on a first surface of a metal substrate to form a non-rigid elastomeric coating comprises a coefficient of static friction of between 0.01 and 1.6. In further examples a mixture of elastomers may comprise one elastomer, two elastomers or greater that two elastomers.

The non-rigid elastomeric coatings herein described, may be reworked. For example, if the elastomeric coating is found to have any surface defects such defects can easily be wiped or washed away with a solvent such as isopropanol, to reveal the substrate layer. The substrate layer can be re-cleaned as described above and a new elastomeric coating applied by EPD. The method of production of the composite materials herein described is also an environmentally clean process whereby the elastomers used are dispersed in water to form the electrolytic solvent or dispersed in polyacrylate polymers and aqueous solvents, rather than using more toxic solvents. Such non-rigid elastomeric coatings may be coated with a functional coating (operation 806), which include anti-fingerprint coatings, anti-bacterial coatings, anti-smudge coatings, or other coatings that provide a functional benefit, and also are suitable for applying metallic finishes that create a metallic luster.

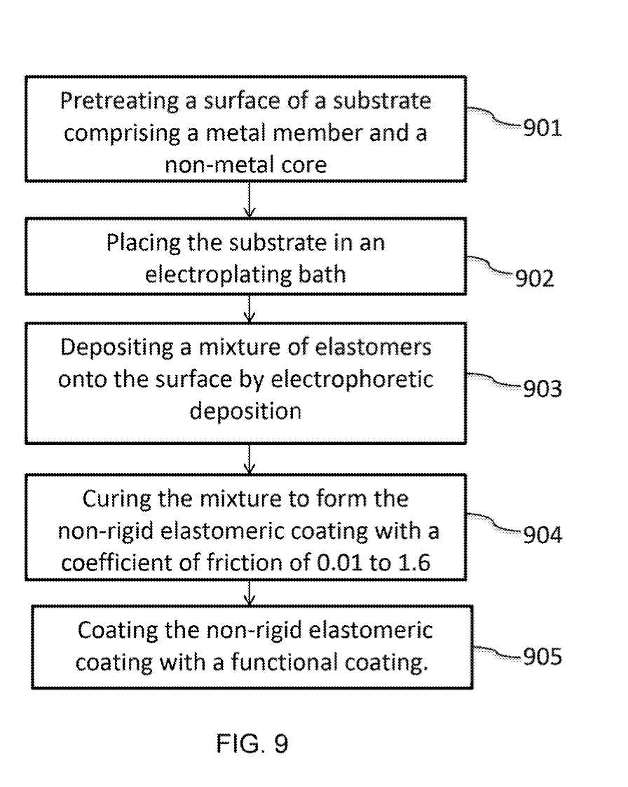

Similarly, any or all of the above examples of composite structures may be formed by the method illustrated in FIG. 9, some operations of which are similar those described above. In operation 901, a substrate comprising a surface, a metal member and a non-metal core is pretreated (as described above). At 902 the substrate is placed in an electroplating bath, At 903 a mixture of elastomers is electrophoretically deposited on the surface. At 904 the mixture is cured to form a non-rigid elastomeric coating with a coefficient of friction of 0.01 to 1.6, and at 905 the non-rigid elastomeric coating is coated with a functional coating.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A composite, comprising:
a substrate including a metal member and a surface; and
a non-rigid elastomeric coating deposited on the surface by electrophorel deposition;
wherein the non-rigid elastomeric coating comprises a coefficient of static friction of 0.01 to 1.6.

2. The composition of claim 1, wherein the surface is one of:
a surface of the metal member;
a surface of an anodized coating on the metal member;
a surface of a Physical Vapor Deposition (PVD) coating on the metal member;
a surface of an electroplated coating on the metal member; and
a surface of an electroless coating on the metal member.

3. The composite of claim 1 wherein the non-rigid elastomeric coating comprises a mixture of a first elastomer and a second elastomer.

4. The composite of claim 3, wherein the first elastomer is a thermoset elastomer, and the second elastomer is a thermoplastic elastomer

5. The composite of claim 4, wherein the ratio of the thermoset elastomer the thermoplastic elastomer is about 3:7.

6. The composite of claim 4, wherein the thermoset elastomer is selected from the group consisting of alkyl acrylate copolymer, butadiene, chlorinated polyethylene (CPE), isobutylene-isoprene copolymer, ethylene propylene (EPM/EPDM), epichlorhydrin (CO/ECO), fluoropolymer, hydrogenated nitrile, isoprene, chloroprene, polysulphide, nitrile, polyurethane (HNBR), silicone, styrene butadiene, tetrafluoroethylene propylene, polyacrylate elastomers, and combinations thereof.

7. The composite of claim 4, wherein the thermoplastic elastomer is selected from the group consisting of urethane elastomers, polyurethane, styrenic block copolymers, copolyether ester elastomers, polyester amide elastomers, and combinations thereof.

8. The composite of claim 1, wherein the non-rigid elastomeric coating is at least one of soluble or disbursed in aqueous solvents.

9. A method of making a composite structure, comprising:
placing a substrate comprising a metal member and having a surface in a coating bath;
mixing a first elastomer, a second elastomer, and water to form a mixture;
depositing the mixture on said surface by electrophoretic deposition; and
curing the mixture to thereby form a non-rigid elastomeric coating.

10. The method of claim 9, further comprising heating the coating bath to a temperature of 20° C. to 30° C.

11. The method of claim 9, wherein curing comprises heating at about 120° C. to about 180° C. for 30 to 60 minutes.

12. The method of claim 9 wherein depositing the mixture comprises depositing the mixture at a rate of 0.1 μm to 2 μm per second.

13. The method of claim 9, further comprising coating the non-rigid elastomeric coating with a functional coat.

14. A method of making a composite material, comprising:
pretreating a surface of a substrate comprising a metal member containing a non-metal core;
placing the substrate in an electroplating bath;
depositing a mixture of elastomers on the surface by electrophoretic disposition;
curing the mixture of elastomers to thereby form a non-rigid elastomeric coating with a coefficient of static friction of between 0.01 and 1.6; and
coating the non-rigid elastomeric coating with a functional coating.

15. The method of claim 14, wherein depositing the mixture comprises depositing the mixture at a rate of 0.1 μm to 2 μm per second to achieve a non-elastomeric coating of 10 μm to about 60 μm thick.
